(19) United States
(12) Patent Application Publication
(10) Pub. No.: US 2012/0285389 A1
(43) Pub. Date: Nov. 15, 2012

(54) PROTECTIVE DEVICE FOR A FOOD BOWL

(76) Inventor: Bernhard Barz, Widnau (CH)

(21) Appl. No.: 13/510,952

(22) PCT Filed: Nov. 19, 2010
(86) PCT No.: PCT/CH10/00292

§ 371 Date: Jul. 8, 2012

(30) Foreign Application Priority Data
Nov. 21, 2009 (DE) 20 2009 015 947.7

(51) Int. Cl. A01K 5/01

(52) U.S. Cl. 119/61.54

(57) ABSTRACT

The protective device for a food bowl (1) with a depression (5) which is surrounded by an edge bead (3) comprises a hold-down device with at least one adjustable hold-down element (13) for holding a cover means (15) in the form of a flexible sheet material within the depression (5), said hold-down element extending into the depression region. The cover means can additionally be held on the food bowl (1) with a peripheral retaining device in the region of the edge bead (3). The cover means (15) can be stored as a detachable section of a rolled-up band in a dispenser (19). The cover means comprises at least one receiving portion (17) on the bottom side thereof for the at least one hold-down element (13).

### TECHNICAL FIELD

The present disclosure generally relates to a protective device for a feeding bowl, and more particularly to a protective device which comprises a cover held in the depression of a feeding bowl by a hold-down device.

### BACKGROUND

The problem with traditional feeding bowls is that dried residue, which is difficult to remove, often remains in the bowl after feeding. For reasons of hygiene, animal feeding bowls should be cleaned regularly. Cleaning, however, is time-consuming and costly, and is often neglected. Protective devices for feeding bowls do exist. They usually come in the form of inserts which are preformed to fit the shape of the feeding bowl. Inserts that are not preformed are also available, but in most cases they do not fit securely in the feeding bowl. They have a tendency to move around and can be pulled out by the animal

An object of the present disclosure is therefore to provide a protective device for a feeding bowl that avoids the disadvantages of known devices.

### SUMMARY

An improved protective device for a feeding bowl, incorporating a protective cover for the bowl, is provided as in the independent claims. Advantageous embodiments of the protective device are provided in the dependent claims. The device incorporates a secure, disposable cover sheet to protect the feeding bowl and thus make it easy and quick to keep clean.

The protective device includes a hold-down device with one or more adjustable hold-down elements that reach into the depressed section of the feeding bowl. The one or more hold-down elements can be pivoted into a loading position. Subsequently, the depression in the feeding bowl is covered with a protective film, or other cover in the form of a flexible sheet material. The bottom side of the cover comprises one or more pocket-like or tube-like receiving portions into which one or more of the hold-down elements can be inserted. After the hold-down elements have been pivoted back down into working position, they press the cover flat against the inside of the depression and secure it in this position.

The peripheral region of the cover is folded over the edge bead which surrounds the depression in the feeding bowl. A continuous annular groove runs around the circumference of the edge bead. The cover is pressed into the annular groove by a retaining ring. The cross sections of the retaining ring and the annular groove are constructed in such a way as to allow the retaining ring to be held securely in place in an interlocking and/or force-fitting manner. The annular groove allows the retaining ring to be connected and released easily. The peripheral region of the cover is clamped securely into position on the feeding bowl and protects it from contamination.

After the food has been eaten, the cover, which can be used once or several times, can be separated from the feeding bowl and disposed of by following the covering procedure in reverse. The dispenser will hold an abundant supply of covers. In a first embodiment of the invention the dispenser may be an independent component that is connected to and released from the feeding bowl. A continuous supply roll of several cover sheets separated by perforations, and thus detachable, may be used. Alternatively, the dispenser may contain a stack of individual covers.

The following detailed description is intended merely to exemplify the invention and to limit the invention or the application and uses of the invention. Furthermore, there is no intention to be bound by any theory presented in the preceding background of the invention or the following detailed description of the invention.

### BRIEF DESCRIPTION OF THE DRAWINGS

FIG. 1 is a plan view of a first arrangement of a feeding bowl with a protective device. The dispenser, from which portions of a rolled-up band of covers are extracted, is connected to the bowl.

FIG. 2 is a side view of the arrangement illustrated in FIG. 1.

FIG. 3 is a cross section of the arrangement illustrated in FIG. 1.

FIG. 4 is a cross section of a detail of the arrangement with the retaining ring inserted in the edge bead.

FIG. 5 is a cross section of a detail of an arrangement with a different retaining ring inserted in the edge bead.

FIG. 6 is a section of a first band with detachable cover in plan view and in cross-section.

FIG. 7 is a section of a different band with detachable cover in bottom-view and in cross-section.

FIG. 8 is a section of a third type of band with detachable cover in plan view and in cross section.

FIG. 9 is a wide hold-down element connected non-rotatably to a shaft.

FIG. 10 is a section of a different band with a detachable cover in bottom-view and in cross-section.

FIG. 11 is a cross-section of an arrangement with a retaining ring pivotally mounted on the edge bead.

### DETAILED DESCRIPTION

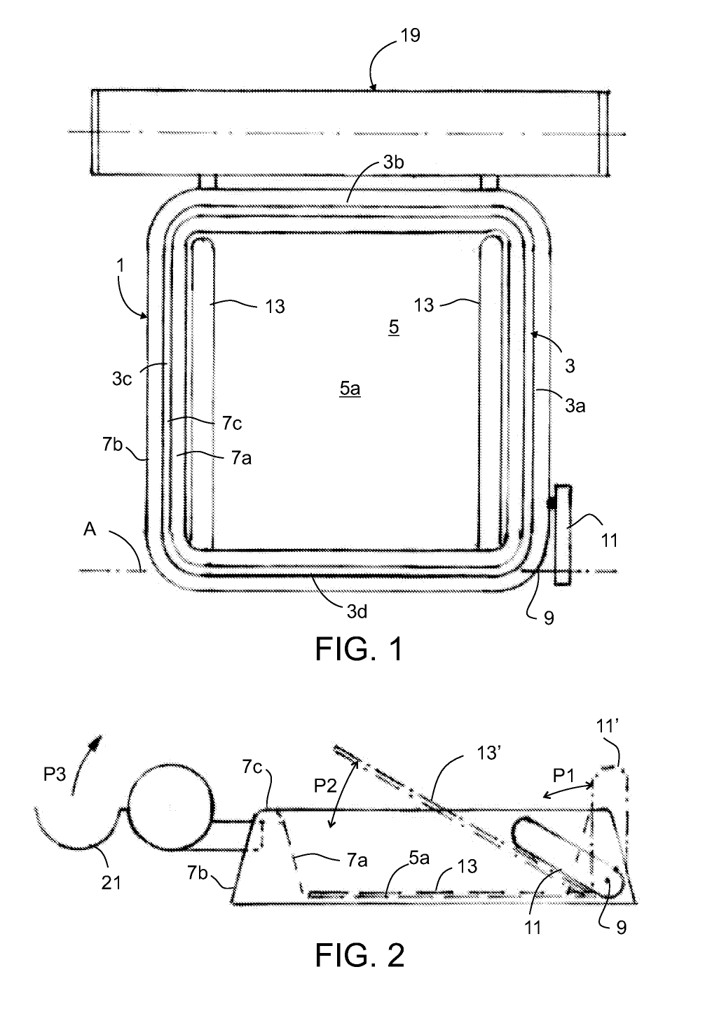

FIG. 1 shows a plan view of a feeding bowl 1 with components of the protective device in a first embodiment. The feeding bowl 1 has a depression 5 surrounded by an edge bead 3. The depression 5 is embedded within pairs of parallel-aligned straight edge bead segments 3a, 3b, 3c, 3d, which are connected by rounded corner sections. The edge bead 3 has a trapezoidal cross section and is bounded laterally by an inner wall 7a and an outer wall 7b and bounded on top by an annular edge 7c. The lower edge of the outer wall 7b is also the base edge of the feeding bowl 1. The lower edge of the inner wall 7a may be slightly higher than the lower edge of the outer wall 7b and abuts the bottom 5a of the depression 5. The area of the edge bead 3 between the inner wall 7a, the outer wall 7b, and the edge 7c is preferably formed as a hollow space; alternatively, it can be formed partially or completely as a solid body.

In the lower part of the edge bead 3 a shaft 9 is mounted parallel to the front edge bead section 3d and pivots about axis A on the edge bead 3. On at least one side the end of the shaft 9 projects laterally from the edge bead 3 and is mounted for co-rotation with an operating lever 11 respectively with a pivoted lever. Inside the edge bead 3 or in a recess 4 (FIG. 11) of the edge bead 3, two rod-like flat tongues which form the hold-down elements 13 are connected to the shaft 9 for co-rotation and protrude parallel to the adjacent edge bead segments 3a, 3c into the depression 5 with the same orientation.

By pivoting the operating lever 11 the hold-down elements 13 can be lowered or raised between a working position and a loading position. In the side view (FIG. 2), the reference numerals 11′ and 13′ indicate the loading positions of the operating lever and hold-down elements respectively; reference numerals 11 and 13 indicate their working positions. The double arrows P1 and P2 illustrate the pivoting of the operating lever 11 and the hold-down elements 13. In the working position the pivot angle is limited because the hold-down elements 13 touch the bottom 5a of the depression or receiving grooves (not shown) at the bottom 5a of the depression; and limited in the loading position because the hold-down elements 13 touch the upper edge of the recess 4 on the inside of the edge bead 3.

It is particularly advantageous if the hold-down device can be locked in the working position and/or the loading position by means of a releasable locking mechanism such as spring-loaded latching elements (not shown). In the working position the hold-down elements 13 push against the bottom 5a of the depression respectively against receiving grooves set therein. They can be held in place against the bottom 5a of the depression by the torque of a spring (not shown) or by their own weight and/or be secured by means of a releasable locking mechanism. This allows a portion of a cover 15 in the form of a flexible sheet material to be held in place by the hold-down elements 13, which clamp it to the bottom 5a of the depression.

The bottom 5a of the depression, or the receiving grooves, may be flat or curved. The shape and size of the hold-down elements is adapted to the shape and size of the bottom 5a of the depression or the receiving grooves within it.

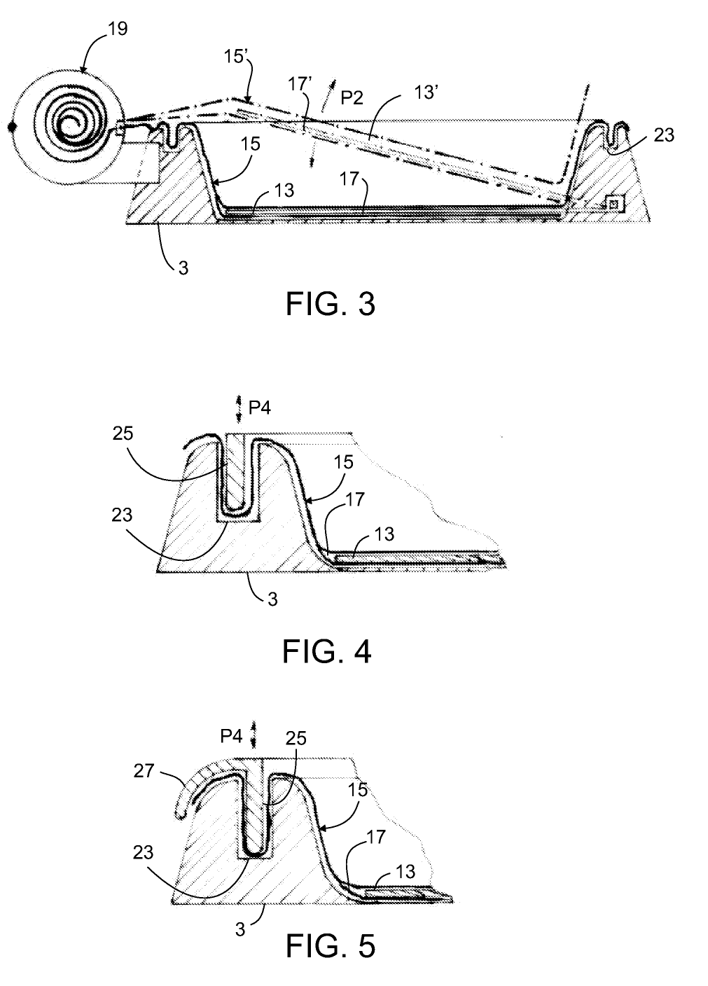

The cover 15 is a plastic film with a receiving portion 17 on its bottom side into which the hold-down elements can be introduced, or which can be looped around the hold-down elements 13 when they are in the loading position. The cover 15 may, for example, be in the form of a rolled-up band of detachable sections which are stored in a dispenser 19. As shown in FIGS. 1 through 3, the dispenser 19 may be a separate component that can be connected to and disconnected from the edge bead 3, or, alternatively, a permanent fixture built on to the edge bead itself. It may include a flip (double arrow P3) cover 21 for inserting and removing rolls of film. The protective device does not necessarily need to have a dispenser 19. Therefore, the feeding bowl 1 may be formed with or without a device for attaching a dispenser 19.

To secure or hold the cover 15 on to the periphery of the feeding bowl 1 an annular groove 23 running around on the top of the edge bead 3 may be provided. The cover 15, which is held inside the depression 5 by one or more hold-down elements 13, overlaps the edge bead 3 and may be clamped there, in the annular groove 23, by a retaining ring 25. The double arrow P4 illustrates the insertion and removal of the retaining ring 25 in the annular groove 23. Preferably, the annular groove 23 and the retaining ring 25 comprise at least in segments complementary retaining structures or profiles which enable a releasable latching connection of the retaining ring 25 and the annular groove 23 with the cover 15 clamped in between (not shown).

FIG. 4 shows a detail of an arrangement with a simple retaining ring 25 inserted in the annular groove 23. FIG. 5 shows a detail of a different arrangement in which the retaining ring 25 has a domed outwardly projecting deck leg 27 which overlaps the outer perimeter of the bead edge 3.

FIG. 11 shows yet another possible arrangement, in which the retaining ring 25 pivots on the upper part of the edge bead 3. The retaining ring 25 is shown in two different pivot positions. As with the hold-down element 13 in FIG. 2, reference numeral 25′ indicates the loading position and reference numeral 25 indicates the working position of the retaining ring 25.

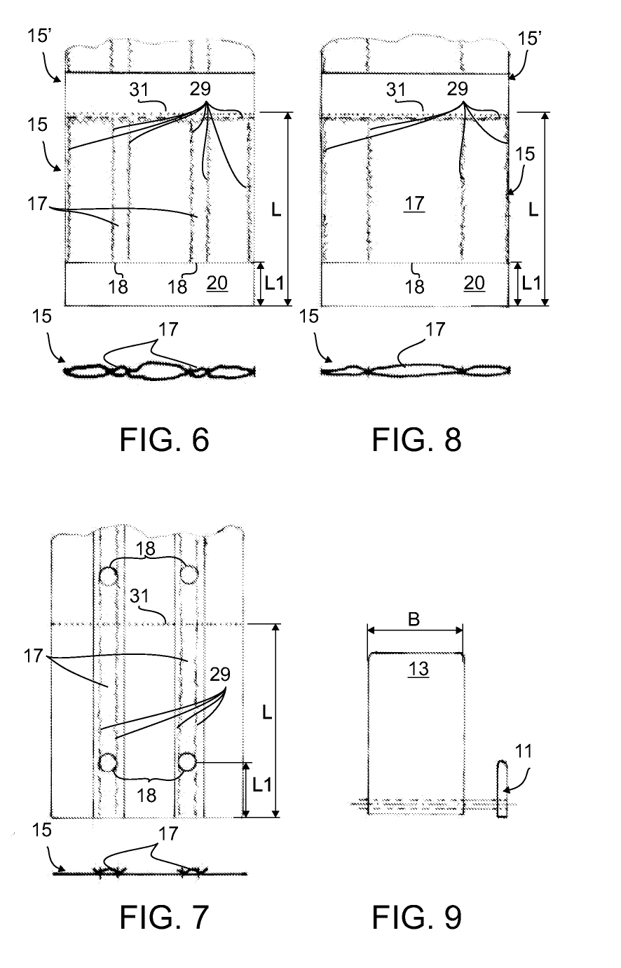

FIGS. 6 through 8 illustrate embodiments of a band of film with a top sheet that is welded, glued, or otherwise connected to a bottom sheet or a partial bottom sheet by welds 29 in a way that creates pocket-shaped or tube-shaped receiving portions 17 which can be slipped over the hold-down elements 13. In the embodiment illustrated in FIG. 6, two narrow receiving portions 17 are formed for two hold-down elements 13 which are arranged near the edge of the bottom 5a of the depression. At the front receiving opening 18 of the receiving portions 17 a flap 20 is formed by a length L1 of the cover 15 without receiving portions 17. This flap 20 can be placed over the front edge bead section 3d after the cover material has been slipped over the hold-down elements 13. A line of perforations 31 runs across the band of cover material, parallel to a weld seam and close to the rear of the receiving portions 17, allowing easy separation from the next portion of cover material 15′.

In the embodiment in FIG. 7, instead of having another film that extends across the entire width of the cover 15, two strip-shaped film sections, welded along their longitudinal edges to the upper film, extend along the entire length L of the cover 15. In this embodiment the receiving openings 18 are in the form of holes in the film strips, into which the rod-shaped hold-down elements 13 are inserted. FIG. 8 shows another embodiment of the cover 15 comprising only one receiving portion 17 which is adapted to receive one wide hold-down element only 13 with the width B, as shown in FIG. 9. The width B is preferably slightly smaller than the width of the bottom 5a of the bowl. A one-piece hold down device may also be used in alternative embodiments of the protective device.

The protective device includes embodiments with or without the shaft 9, with or without an operating lever 11 attached to it.

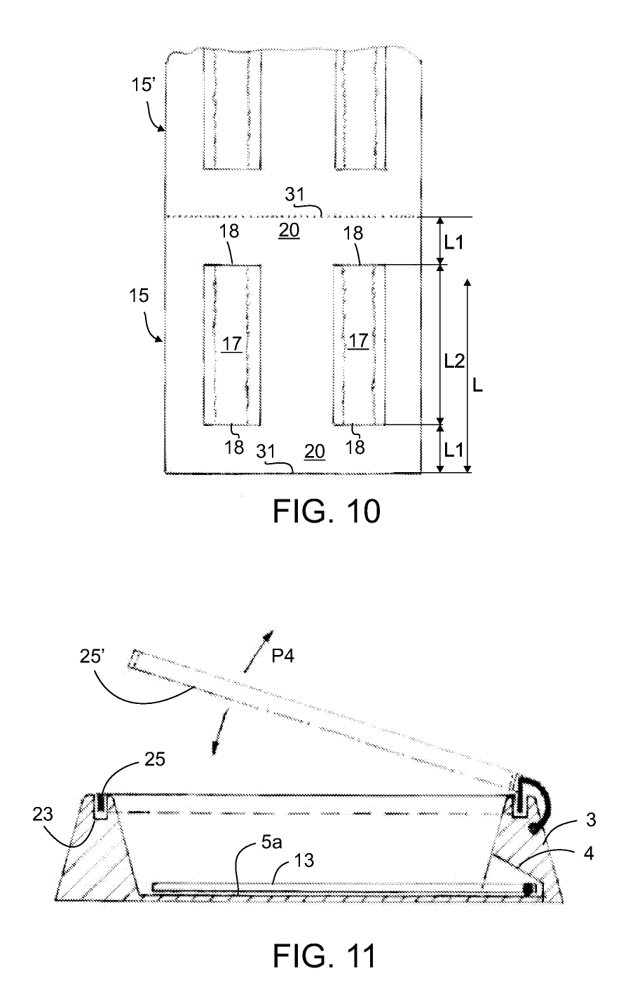

FIG. 10 shows a section of another band with cover 15, from below. Here, two strip-shaped film sections are welded as receiving portions 17 along their longitudinal edges on the bottom side of the cover film. The length L2 of these film sections provides a flap 20 of the length L1 on both sides, between the receiving openings 18 and the adjacent perforation edges 31. This flap 20 is folded over the edge bead segments 3b and 3d of the feeding bowl 1. In the same way, there is also sufficient film on the longitudinal sides of the strips for them to be folded over the lateral edge bead segments 3a, 3c.

Of course, the protective device may also be adapted for use in feeding bowls 1 with differently shaped depressions. Likewise, the cover 15 may have a different form and be adapted to differently shaped bowls.

While the present invention has been described with reference to exemplary embodiments, it will be readily apparent to those skilled in the art that the invention is not limited to the embodiments disclosed or illustrated here. On the contrary, the invention is intended to accommodate numerous modifications, substitutions, variations and broad equivalent arrangements included within the spirit and scope of the following claims.

1.-11. (canceled)

12. A protective device for a feeding bowl having a depression for receiving food which is surrounded by an edge bead, comprising:
a cover made of a flexible sheet material for lining the depression and
a hold-down device connected to the feeding bowl,
wherein the hold-down device comprises at least one adjustable hold-down element which reaches into the depression for holding the cover within the depression.

13. The protective device as in claim 12,
further comprising shaft which is pivotally connected to the edge bead and to which the at least one adjustable hold-down element is rigidly connected and
an operating lever connected to the shaft,
wherein the shaft can be pivoted between a loading position for attaching the cover to and removing the cover from the hold-down element and a working position for holding down the cover within the depression by the operating lever.

14. The protective device as in claim 13,
wherein the edge bead comprises a straight section where the shaft is connected to the edge bead.

15. The protective device as in claim 13,
wherein at least one end of the shaft protrudes outwardly beyond the edge bead, and
wherein the operating lever is connected to the at least one end of the shaft which protrudes outwardly beyond the edge bead.

16. The protective device as in claim 13,
further comprising a locking mechanism for releasably locking the hold-down element in the loading position, or in the working position, or in both the loading position and the working position.

17. The protective device as in claim 12,
wherein the hold-down device comprises at least two rod-shaped hold-down elements.

18. The protective device as in claim 12,
further comprising a retaining device for attaching the cover to the edge bead.

19. The protective device as in claim 18,
wherein the retaining device comprises a circumferential annular groove in the edge bead and a retaining ring,
and wherein the retaining ring can be at least partially inserted into the annular groove to clamp the cover between the retaining ring and the annular groove.

20. The protective device as in claim 19,
wherein the retaining ring is pivotally connected to the edge bead, or is a separate component that can be attached to and detached from the edge bead.

21. The protective device as in claim 19,
wherein the retaining ring is releasably connected to the edge bead in an interlocking manner, a force-fitting manner, or both an interlocking and a force-fitting manner.

22. The protective device as in claim 12,
further comprising a dispenser configured for receiving a plurality of covers which are rolled up into a roll or stacked in separable layers, the dispenser being releasably connectable to the feeding bowl.

23. The cover for the protective device as in claim 12,
comprising at least one receiving portion with a receiving opening for introducing the at least one hold-down element, the at least one receiving portion being formed on the bottom side of the flexible sheet material.

24. The cover as in claim 23,
wherein the flexible sheet material comprises two layers of film which are welded or otherwise connected to each other such that the at least one receiving portion is formed as a pocket or as a tubular portion between the two layers of film.

25. The cover as in claim 23,
wherein the cover is formed as a detachable portion of a band which comprises a plurality of covers that are separable along a transverse line of perforations.
